(19) United States
(12) Patent Application Publication
(10) Pub. No.: US 2020/0062256 A1
(43) Pub. Date: Feb. 27, 2020

(54) METHOD AND DEVICE FOR RESERVE DRIVING OF A VEHICLE

(71) Applicant: Robert Bosch GmbH, Stuttgart (DE)

(72) Inventors: Wolfgang Mueller, Stuttgart (DE); Ahmet Kilic, Boeblingen (DE); Henrick Brandes, Ludwigsburg (DE)

(21) Appl. No.: 16/462,814

(22) PCT Filed: Oct. 4, 2017
(86) PCT No.: PCT/EP2017/075164

§ 371 Date: May 21, 2019

(30) Foreign Application Priority Data
Nov. 22, 2016 (DE) 10 2016 222 969.9

(51) Int. Cl. B60W 30/18; B60H 1/00; B60W 10/30

(52) U.S. Cl. CPC B60W 30/18036; B60W 2050/0292; B60W 10/30; B60H 1/00428

(57) ABSTRACT

The invention relates to a method (100) and to a device (450) for reserve driving of a vehicle (400), wherein the vehicle (400) comprises a drive unit (410), an auxiliary unit (420) having a drive (430) associated with the auxiliary unit (420), and at least one wheel (440). The wheel (440) is designed to roll on the ground at least during reserve driving of the vehicle (400) or during the travel of the vehicle (400). The device (450) is designed to detect a failure of the drive unit (410); to couple the drive (430) of the auxiliary unit (420) to the wheel (440); and to operate the drive (430) of the auxiliary unit (420) for the reserve driving of the vehicle (400).

### BACKGROUND OF THE INVENTION

The invention relates to a method and a device for reserve driving of a vehicle. The invention further relates to a drive train with a corresponding device, a vehicle with a corresponding drive train, as well as a computer program and a machine-readable storage medium.

Vehicles aid mobility. Vehicles require a drive unit to be able to do this. This is operated in such a way that the vehicle moves, for example with a corresponding payload. If the drive unit fails, or if it is defective, the vehicle is no longer able to move under its own power. There are situations and a great many locations in which a vehicle becomes a problem for the environment, in particular for other vehicles, and thus constitutes a danger to the environment, or also to the occupants seated therein, for example. The need exists, therefore, in the event of failure of the drive unit, to move the vehicle away from the danger zone to a location in which the danger is reduced or eliminated.

### SUMMARY OF THE INVENTION

A method for reserve driving of a vehicle is proposed. The vehicle in this case comprises a drive unit, an auxiliary unit having a drive associated with the auxiliary unit and at least one wheel, which is adapted to roll on the ground as the vehicle is driven. The method comprises the following steps: detection of a failure of the drive unit; connection of the drive of the auxiliary unit to the wheel; operation of the drive of the auxiliary unit for reserve driving of the vehicle.

A method for reserve driving of a vehicle is proposed. The vehicle is generally driven by a drive unit envisaged for its operation as intended. Reserve driving allows the provision of an emergency drive for the vehicle. In the event of a failure of, or a defect in the drive unit, the vehicle can be at least moved away from a danger zone with the reserve drive and can preferably be parked in a safe location. The vehicle comprises one or multiple drive units for its operation as intended. These drive units operate the vehicle during the normal operation of the vehicle. In particular, they convert the energy available in the vehicle into in particular translational or rotational energy, which is preferably transmitted to a wheel or to a drive wheel of the vehicle and thus serves to drive the vehicle. The vehicle further comprises at least one auxiliary unit having a drive associated with the auxiliary unit. This auxiliary unit is a unit which does not serve to drive the vehicle during operation of the vehicle as intended. In particular, during normal operation of the vehicle, its energy is not transmitted to a wheel that serves for driving or accelerating the vehicle. The auxiliary unit preferably serves for the operation or driving of, for example, an air-conditioning compressor for the air-conditioning system, a seat adjustment or an opening and closing mechanism for a roof of a convertible vehicle. Suchlike auxiliary units require a drive, preferably an electric motor, for their operation. The vehicle further comprises at least one wheel. This is adapted to roll on the ground, at least during reserve driving of the vehicle or while driving during movement of the vehicle on the ground or on the road on which the vehicle is present. The method comprises the step of detecting a failure of or a defect in the drive unit. It is detected that the drive unit that is present for the normal deriving of the vehicle has failed and is thus no longer available. The reason for the failure is preferably a defect in the drive unit itself or in a component of the vehicle that is of relevance to the operation of the drive unit. In a further step, the drive of the auxiliary unit is connected to the wheel. The drive of the auxiliary device is then operated for reserve driving of the vehicle. The drive of the auxiliary unit then drives the vehicle, which in the process is preferably moved away from a danger zone. Advantageously, a method is thus proposed which makes it possible, in the event of failure of the drive unit, to drive the vehicle by means of the reserve drive and to move it away from a danger zone.

In another embodiment of the invention, the drive unit is an internal combustion engine, a first hydrostatic drive or an electric drive motor.

The drive unit provided for the normal operation of the vehicle is an internal combustion engine, for example. The drive unit can also be a first hydrostatic drive, which finds an application in construction machines or agricultural machines and tractors, for example. In electric vehicles, the drive unit is an electric drive motor. The expression drive unit of the vehicle in this context also preferably comprises the components that are relevant for the operation of the respective drive unit. For example, this could be a first power electronics unit for controlling an electric drive motor or a fuel supply system for supplying an internal combustion engine. Advantageously, a number of variants of suitable drive units for a vehicle are proposed.

In another embodiment of the invention, the drive for the auxiliary unit is a second hydrostatic drive or an electric motor.

In the agricultural sector in particular, auxiliary units are driven by means of hydrostats or hydrostatic drives, for example a seed drill mounted on a tractor. Different auxiliary units in a vehicle are driven by means of an electric motor, for example an air-conditioning compressor. Advantageously, variants for driving an auxiliary unit are proposed.

In another embodiment of the invention, a failure of the drive unit prevents driving of the vehicle with the drive unit.

A failure of the drive unit may be caused, for example, because of a mechanical defect in the drive unit itself. For example, rupturing of the casing of the drive unit. Another possibility for a failure of the drive unit occurs, for example, when the energy supply to the drive unit is interrupted. In internal combustion engines or also in hydrostatic drives, this may be a leak in the supply of the fuel or the hydraulic oil. In electric motors, this can be a defect in the first power electronics unit. A further reason for the failure of a drive unit is also the absence of the energy required for its operation. In the case of internal combustion engines, this can be due to a lack of fuel as a result of an empty tank. Hydrostatic drives only function correctly, for example, with an adequate supply of hydraulic oil. Electric drive units require sufficient electrical energy. This energy is not available in the case of a discharged first battery allocated to the drive unit. These possibilities result in the failure of the drive unit, so that driving of the vehicle with the drive unit is prevented and becomes impossible. Advantageously, various possibilities are proposed which result in failure of the drive unit. The vehicle can be moved away from a danger zone by means of the reserve drive, in spite of failure of the drive unit.

In another embodiment of the invention, the method comprises an additional step: at least partial separation of the drive of the auxiliary unit from the auxiliary unit.

The drive of the auxiliary unit is preferably separated at least partially from the auxiliary unit before the reserve drive is engaged. Advantageously, the normal load of the drive of the auxiliary unit is separated hereby from the drive, so that the drive of the auxiliary unit is able to provide more power, or preferably the same power, for reserve driving of the vehicle. The separation of the drive from the auxiliary unit is preferably executed before connecting the dive of the auxiliary unit to the wheel.

The invention further relates to a computer program, which is adapted to execute one of the previously described methods.

The invention further relates to a machine-readable storage medium, on which the described computer program is stored.

The invention further relates to a device for reserve driving of a vehicle. The vehicle comprises a drive unit, an auxiliary unit having a drive associated with the auxiliary unit and at least one wheel. The wheel is adapted to roll on the ground, at least during reserve driving of the vehicle. The device is adapted to detect a failure of the drive unit, to couple the drive of the auxiliary unit to the wheel, and to operate the drive of the auxiliary unit for reserve driving of the vehicle.

A device for reserve driving of a vehicle is proposed. Reserve driving permits the provision of an emergency drive for the vehicle, with which the vehicle, following a failure of the drive unit provided for the drive of the vehicle as intended, can at least be moved away from a danger zone and can preferably be parked in a safe location. The device is adapted to detect a failure of the drive unit, to connect the drive of the auxiliary unit to the wheel, and to operate the drive of the auxiliary unit for reserve driving of the vehicle. Appropriate means, preferably control units with sensor devices and actuator devices, are provided for this purpose. The drive of the auxiliary device accordingly drives the vehicle, which in this case is preferably moved away from a danger zone. Advantageously, a device is thus proposed which permits driving of the vehicle by means of reserve driving in spite of a failure of the drive unit of the vehicle. The vehicle can thus be moved away from a danger zone, for example.

In another embodiment of the invention, the driven auxiliary unit is an electric air-conditioning compressor, whereas the drive of the air-conditioning compressor is an electric motor.

With the increasing electrical output that is available in vehicles, air-conditioning compressors, which possess an output of several kilowatts, are increasingly driven by electric motors. In this embodiment of the invention, the auxiliary unit is an air-conditioning compressor, and the drive of the driven auxiliary unit is an electric motor. Advantageously, a driven auxiliary unit is proposed, which produces sufficient output for effective reserve driving of a vehicle.

In another embodiment of the invention, the device is equipped with a coupling device for coupling the drive of the auxiliary device to the wheel.

A coupling device for coupling the drive of the auxiliary device to the wheel can comprise, for example, a clutch, a planetary gearbox and/or a supplementary gearbox. A supplementary gearbox permits the adaptation of the speed and/or the torque of the drive of the auxiliary unit for its operation as a reserve drive for the vehicle. Coupling of the drive of the auxiliary unit to the wheel can take place directly or indirectly. This means that the drive of the auxiliary unit is in a direct operative connection with the wheel to be driven, or that a coupling is produced indirectly with a shaft, which is optionally in connection with the wheel via further gearboxes or units. It will be appreciated that this coupling device is open during normal operation of the vehicle, and that it is preferably opened in an automatic or controllable manner. This coupling device is preferably connected only in the event of a failure of a drive unit being detected. The coupling can be reinstated in particular after correcting the failure of the drive unit.

In another embodiment of the invention, the device comprises a separating device for the at least partial separation of the drive of the auxiliary unit from the auxiliary unit.

A separating device is proposed for the at least partial separation of the drive of the auxiliary unit from the auxiliary unit. The separation of the auxiliary unit from the drive of the auxiliary unit is executed in order to enable more output, or the entire output of the drive of the auxiliary unit to be made available for the emergency driving of the vehicle. It will be appreciated that this separation device is preferably closed during normal operation of the vehicle, and that the drive of the auxiliary device is connected to the auxiliary unit once more in particular after correcting the failure of the drive unit.

The invention further relates to a drive train having a device as described, and preferably having an auxiliary unit with a drive. A suchlike drive train serves, for example, for driving a vehicle which is driven with an internal combustion engine, by means of an electric motor or by means of a hybrid drive. Reliable operation of the drive train is facilitated by means of the method and the device.

The invention further relates to a vehicle having a drive train as described. Advantageously, a vehicle is thus proposed which comprises a device with which the emergency operation of the vehicle is facilitated.

It will be appreciated that the characterizing features, properties and advantages of the inventive method are accordingly relevant and applicable to the method, and vice versa, and respectively to the drive train and the vehicle. Further characterizing features and advantages of embodiments of the invention can be found in the following description with reference to the accompanying drawings.

### BRIEF DESCRIPTION OF THE DRAWINGS

The invention is now described in more detail below with reference to a number of figures, in which:

FIG. 1 depicts a schematically represented vehicle having a drive train and a device for the emergency driving of a vehicle.

FIG. 2 depicts a schematically represented flow chart for a method for the emergency driving of a vehicle.

### DETAILED DESCRIPTION

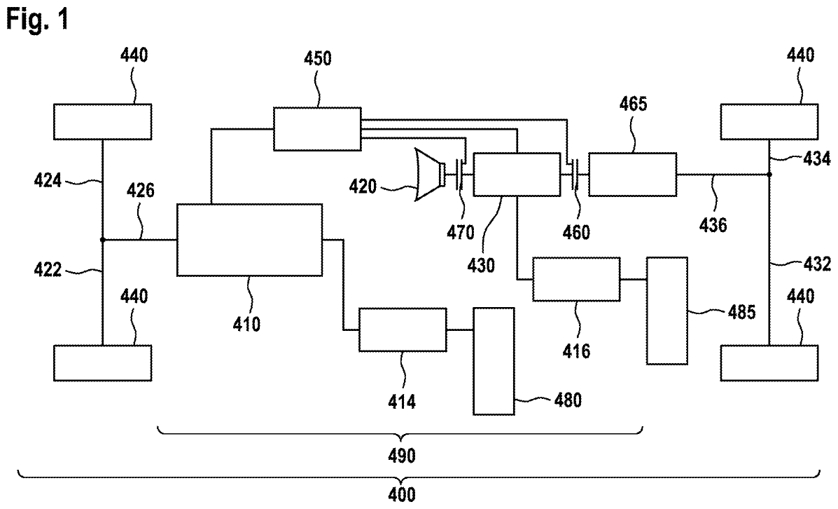

FIG. 1 depicts a schematically represented vehicle 400 with wheels 440. FIG. 1 further depicts a schematically represented drive train 490 having a device 450 for reserve driving of the vehicle 400. The drive train 490 is connected on the one hand via the drive shaft 426, 422, 424 to a driving axle of the vehicle 400, and via the drive shaft 436, 434, 432 to a further driving axle of the vehicle 400. In particular, the drive train 490 comprises at least one of the components mentioned below. The device 450, which is adapted to detect a failure of the of a drive unit 410. The drive unit 410 is, for example, an internal combustion engine, a first hydrostatic drive or an electric drive motor. This drive unit is supplied with energy from the component 480 by means of a component 414. If the drive unit is configured as an internal combustion engine, for example, the component 414 is a fuel pump and the component 480 is a fuel tank. If the component 410 is an electric motor, for example, the component 414 is configured as a first power electronics unit, in particular as an inverter or a voltage transformer, which transforms electrical energy from a first battery 480, that is to say a DC voltage into an AC voltage, for the supply of the electric motor 410. If the device 450 detects a failure of the drive unit 410, which can also occur, for example, as the result of a defect or a failure of the relevant components 414 or 480 for the operation of the respective drive unit 410, the device 450 actuates in particular a first clutch 470 for the separation of the driven auxiliary unit 420 from its drive 430. The device 450 further actuates a second clutch 460 for connecting the drive 430 of the auxiliary unit 420, in particular via a further gearbox or a coupling interface 465, to a wheel 440. According to the illustrative embodiment in FIG. 1, the drive 430 of the auxiliary unit 420 in this case is in operative connection with a wheel 440 via the shaft 436 and at least one of the shafts 434, 432. The device 450 actuates the drive 430 in such a way that reserve driving and/or emergency driving of the vehicle 400 is facilitated, and in particular in such a way that the vehicle can be moved away from a danger zone. Further represented by way of example in FIG. 1 is a second power electronics unit 416, which transforms the DC voltage from a second battery 485 into an AC voltage for driving the electric motor of the drive 430 of the auxiliary unit 420. As an alternative, in the event of a defect in the first battery 480, the second battery 485 could serve for the supply of the second power electronics unit 416 and the first power electronics unit 414, if said second battery 485 were to be connected to the first power electronics unit 414.

For example, the auxiliary unit 420 is an air-conditioning compressor, which is driven by an electric motor 430 as a drive for the auxiliary unit. A second power electronics unit 416 is envisaged for the normal operation of the air-conditioning compressor 420. The vehicle 400 is preferably driven by an electric drive motor 410. In the event of a fault in the electric drive motor 410 or the associated first inverter 414, a redundant electric motor 430 and a second inverter 416 are available to supply the drive 430 as a reserve drive. Advantageously, the electric drive 430 for the auxiliary unit can be used in a twofold manner. This is a cost-effective solution for a redundant drive, which, should the need arise, can avoid a possible accident or a danger. A further advantage is that the weight of a second, additional drive motor does not have to be carried. There is thus also a saving in installation space. It will be appreciated that the invention also lends itself to use on other topologies of the most varied vehicle types.

A connection of the drive 430 of the auxiliary unit can be provided both directly to an individual wheel 440 and indirectly via further shafts 436, 434, 432 between the drive 430 of the auxiliary unit and the wheel, for example to a second axle of the vehicle or to the shaft 424, 422. Reserve driving can thus be provided via an individual wheel 440, via a rear-axle drive, a front-axle drive or a connection to some other point in the drive train. If, for example for emergency operation, the auxiliary unit 420, in particular an air-conditioning compressor, is separated from the drive 430 by means of the separating device 470, the comfort function of the cooling will be deactivated and/or severely restricted, for example in the case of an only partial separation within the scope of the statutory provisions. In particular the first and the second batteries 485, 480, which can also be configured in particular as a single common battery, are not restricted to a particular voltage level. The voltage of these batteries 485, 480 can lie both in the low-voltage range, in particular such as 12 Volts or 48 Volts in the case of on-board wiring systems, or in the high-voltage range, in the order of 100 Volts to 900 Volts for traction systems. In addition, this topology can be used both in conventional vehicles and in autonomous vehicles.

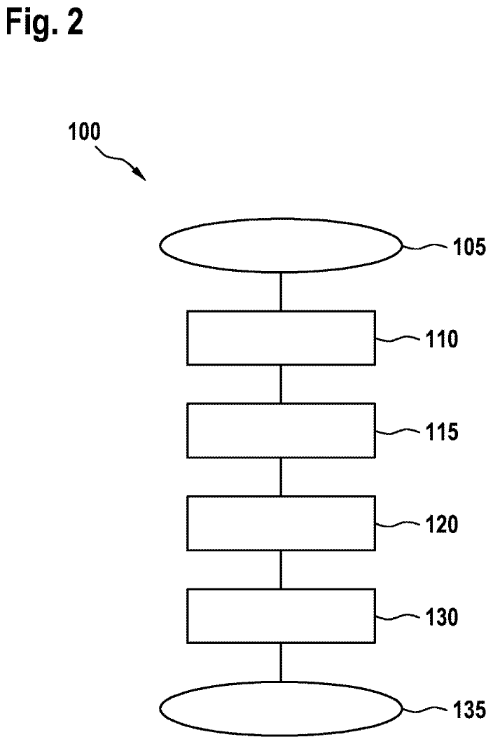

FIG. 2 depicts a method 100 for reserve driving of a vehicle 400. The method starts with step 105. The method further comprises the following steps: detection 110 of a failure of the drive unit 410; at least partial separation 115 of the drive 430 for the auxiliary unit 420 from the auxiliary unit 420. In step 120, the drive 430 for the auxiliary unit 420 is connected to the wheel 440. In step 130, the drive 430 for the auxiliary unit 420 is operated for reserve driving of the vehicle 400. The method ends with step 135.

1. A method (100) for reserve driving of a vehicle (400), wherein the vehicle (400) comprises a drive unit (410), an auxiliary unit (420) having a drive (430) associated with the auxiliary unit (420) and at least one wheel (440),
wherein the wheel (440) is adapted to roll on the ground at least during reserve driving of the vehicle (400),
having the steps:
detection (110) of a failure of the drive unit (410);
connection (120) of the drive (430) of the auxiliary unit (420) to the wheel (440);
operation (130) of the drive (430) of the auxiliary unit (420) for reserve driving of the vehicle (400).

2. The method as claimed in claim 1, wherein the drive unit (410) is an internal combustion engine, a first hydrostatic drive or an electric drive motor.

3. The method as claimed in claim 1, wherein the drive (430) of the auxiliary unit (420) is a second hydrostatic drive.

4. The method as claimed in claim 1, wherein a failure of the drive unit (410) prevents driving of the vehicle (400) with the drive unit (410).

5. The method as claimed in claim 1 claim 1, wherein the method (100) comprises an additional step:
at least partial separation (115) of the drive (430) of the auxiliary unit (420) from the auxiliary unit (420).

6. A non-transitory machine-readable storage medium storing a computer program, which is configured to execute the method (100) as claimed in claim 1.

7. (canceled)

8. A device (450) for reserve driving of a vehicle (400), wherein the vehicle (400) comprises a drive unit (410), an auxiliary unit (420) having a drive (430) associated with the auxiliary unit (420) and at least one wheel (440),
wherein the wheel (440) is adapted to roll on the ground at least during reserve driving of the vehicle (400) or during the travel of the vehicle (400),
wherein the device (450) is adapted
to detect a failure of the drive unit (410); to couple the drive (430) of the auxiliary unit (420) to the wheel (440), and to operate the drive (430) of the auxiliary unit (420) for the reserve driving of the vehicle (400).

9. The device as claimed in claim 8, wherein the driven auxiliary unit (420) is an electric air-conditioning compressor and the drive (430) of the air-conditioning compressor is an electric motor.

10. The device as claimed in claim 8 having a coupling device (460) for coupling the drive (430) of the auxiliary unit (420) to the wheel (440).

11. The device as claimed in claim 8, having a separating device (470) for the at least partial separation of the drive (430) of the auxiliary unit (420) from the auxiliary unit (420).

12. A drive train (490) having a device (450) as claimed in claim 8.

13. A vehicle (400) having a drive train (490) as claimed in claim 12.

14. The method as claimed in claim 1, wherein the drive (430) of the auxiliary unit (420) is an electric motor.
